(19) United States
(12) Patent Application Publication
(10) Pub. No.: US 2006/0077908 A1
(43) Pub. Date: Apr. 13, 2006

(54) Method for generating and authenticating address automatically in IPv6-based internet and data structure thereof

(76) Inventors: So Hee Park, Daejeon-city (KR); Jae Hoon Nah, Daejeon-city (KR); Kyo Il Chung, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/081,388

(22) Filed: Mar. 15, 2005

(30) Foreign Application Priority Data
Oct. 7, 2004 (KR) 10-2004-0079859

(51) Int. Cl. H04L 12/28

(52) U.S. Cl. 370/254

(57) ABSTRACT

Provided are a method for automatically generating an address in the IPv6-based Internet when a sender having a pair of a public key and a private key establishes a network connection, and a data format thereof. The method includes generating a CGA address and a CGA option based on the public key and a predetermined parameter, generating a signature option for verifying the CGA option, additionally generating a timestamp option in a case where a unidirectional message is transmitted to the network, and additionally generating a nonce option containing random numbers in a case where a bidirectional message is transmitted to the network, and adding the signature option, the timestamp option and the nonce option to a Neighbor Discovery (ND) option field to form an ND message, and transmitting the ND message to the network. When a host enters the network in a Zero Configuration over the IPv6-based Internet, the host can securely generate its own address without using a manual key. The method can also be applied to general IPv6 packet authentication or position authentication of a mobile node.

This application claims the priority of Korean Patent Application No. 10-2004-0079859, filed on Oct. 7, 2004, in the Korean Intellectual Property Office, the disclosure of which is incorporated herein in its entirety by reference.

### BACKGROUND OF THE INVENTION

1. Field of the Invention

The present invention relates to a method of rendering information protection service in the Internet Protocol version 6 (IPv6) based internet, and more particularly, to a method for generating an address automatically by imparting additional security options to a conventional Internet Control Message Protocol version 6 (ICMPv6) message, thereby generating the address in a secured manner, and a data structure thereof.

2. Description of the Related Art

A conventional IPv6-based Internet is basically constructed to enable zero configuration in which a host can communicate with another host on a local link without prior configuration. In order to protect signaling messages enabling such communications, IP Security Protocol Authentication Header (Ipsec AH) is generally used. However, since the IPsec technique provides security for a prescribed IPv6 address, it is not suitably adopted to the IPv6-based Internet in which an address is automatically generated.

In other words, when a security negotiation is exchanged in a bootstrapping state in which an IPv6 address is not set, a chicken-and-egg problem may be generated due to Internet Key Exchange (IKE) protocol. In addition, only manual keys are usable due to a bootstrapping problem, which makes it substantially impossible to adopt the IPsec technique in the actual network environments.

### SUMMARY OF THE INVENTION

The present invention provides a method of providing information protection for IPv6-based Internet service, particularly, a method for automatically generating an address in the presence of security when a non-configured host establishes an Internet connection for the first time, and a data format thereof.

According to an aspect of the present invention, there is provided a method for automatically generating an address in the IPv6-based Internet when a sender having a pair of a public key and a private key establishes a network connection, the method comprising: generating a CGA address and a CGA option based on the public key and a predetermined parameter; generating a signature option for verifying the CGA option; additionally generating a timestamp option in a case where a unidirectional message is transmitted to the network, and additionally generating a nonce option containing random numbers in a case where a bidirectional message is transmitted to the network; and adding the signature option, the timestamp option and the nonce option to a Neighbor Discovery (ND) option field to form an ND message, and transmitting the ND message to the network.

According to another aspect of the present invention, there is provided a method for authenticating an IPv6 address generated by a sender that has received an IPv6 message with a timestamp/nonce option, a signature option, and a CGA option added thereto, the method comprising: verifying a timestamp/nonce option; if the verifying of the timestamp/nonce option is successfully completed, checking the message whether it is a bidirectional message or a unidirectional message, and verifying the nonce option for the bidirectional message or verifying the signature option for the unidirectional message; and if the verifying of the time stamp is successfully completed, verifying the CGA option to check a CGA address, and authenticating the IPv6 address.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates a format of a Neighbor Discovery (ND) protocol message among conventional Internet Control Message Protocol Version 6 (ICMPv6) messages for automatically generating addresses in layers of Internet Protocol Version 6 (IPv6) based Internet to which the present invention is applied;

FIG. 2 illustrates a format of an ND message with an ND security option added for automatically generating addresses whose security is ensured in the IPv6-based internet;

FIG. 3A illustrates a data packet of a CGA option as the added ND security option in the IPv6-based internet, FIG. 3B illustrates a data packet of a signature option as the added ND security option in the IPv6-based internet; and FIGS. 3C and 3D illustrate data packets of timestamp/nonce options as added ND security options in the IPv6-based internet; and

FIG. 4A is a flow chart diagram illustrating a process in which a non-configured sender that first enters the network automatically generates its own IPv6 address and sends it; and FIG. 4B is a flow chart diagram illustrating a process in which a receiver that receives a message transmitted by the sender, verifies the automatically generated IPv6 address and authenticates the same.

### DETAILED DESCRIPTION OF THE INVENTION

Hereinafter, preferred embodiments of the present invention will be described in detail with reference to the attached drawings.

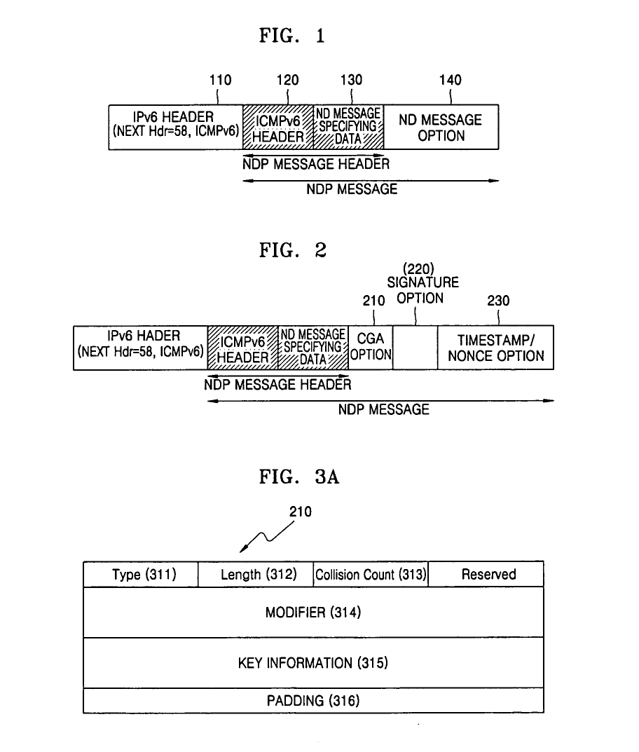

Referring to FIG. 1, to enable communications on a local link, a conventional IPv6-based Internet protocol sets a default router using an ND protocol as a neighbor node searching protocol, maps an IP address to an MAC address, and acquires network prefix information.

Then, the host acquires information on a network to which it belongs based on the network prefix information for communication. An ND message is based on ICMPv6.

FIG. 1 illustrates a format of an ND message, which consists of an ND message specifying data field 130 and an option field 140 and is preceded by an ICMPv6 header 120. When the ND message is received at an IPv6 layer, an IPv6 header 110 is added to the forefront stage of a packet.

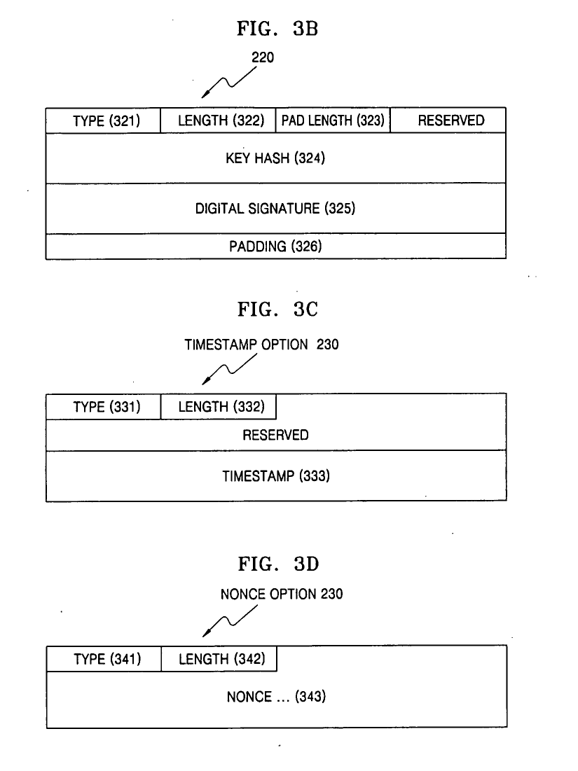

FIG. 2 illustrates a format of an ND message with an ND security option added for automatically generating addresses whose security is ensured in the IPv6-based internet. The ND message with an ND security option includes a CGA option 210 for generating a CGA address using a public key, a signature option 220 for authenticating an IPv6 message existing prior to signature option by signing a private key, and a timestamp/nonce option 230 for retransmission tolerance service.

Specifically, for the timestamp/nonce option 230 the time stamp option is used for a unidirectional message which is sent from sender or receiver, and the nonce option is used with the time stamp option for a bi-directional message for increasing a security level.

When the CGA option 210 is additionally used for automatically generating a secured address at the sender, the signature option 220 should be essentially added for verifying the address.

In addition, when the signature option 220 is additionally used, the timestamp/nonce option 230 should be essentially added for retransmission attack tolerance. When the receiver receives an IPv6 message that is not provided with the three options, the message should be removed.

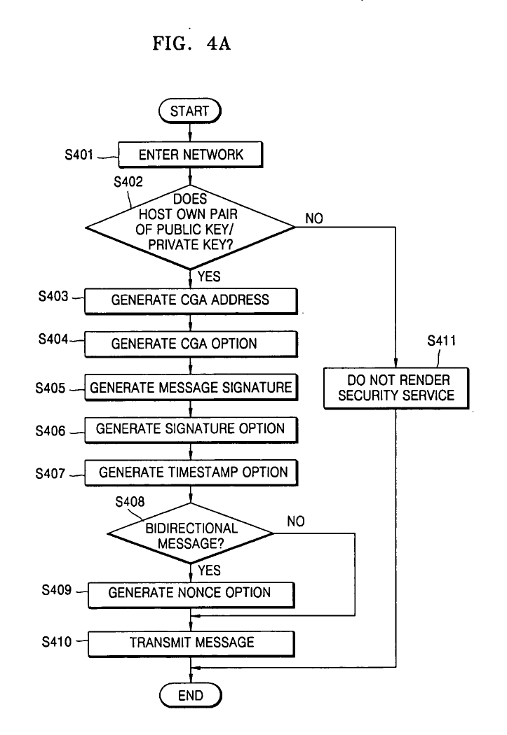

FIGS. 3A through 3D illustrate data formats of three options according to the present invention.

Referring to FIG. 3A, the CGA option 210 is an option that provides security in an environment in which a security infrastructure does not exist, and it is claimed through a CGA address that an ND message sender is an authentic owner of a claimed address.

Since a public key is used in generating the CGA address, however, every node should hold a pair of a public key and a private key before generating its own CGA address. In other words, a host should have its own key when it enters the network for the first time.

The sender executes a unidirectional hash function on its own interface ID using the public key and a predetermined tentative parameter. In order to generate a 128-bit IPv6 address cryptographically, 64-bit values extracted among hash values that are previously generated are connected to 64-bit prefix of the network. If the CGA address generated by the sender is transmitted through the CGA option 210, a receiver verifies the CGA address based on the CGA option 210.

As shown in FIG. 3A, the CGA option 210 includes a type field 311 representing a CGA option among ND options, a length field 312 representing the overall length of the option field in units of 64 bits, a collision count field 313 representing occurrence of collision in the course of checking duplicity of the generated CGA address, a modifier field 314 representing a 128-bit random number used to increase a security level when generating the CGA address, a key information field 315 representing a sender's public key, and a padding field 316 for alignment of packets.

The collision count field 313 may have one of values 0,1,2 and it increases by 1 whenever collision occurs.

That is to say, when collision occurs three times, packet processing is terminated and an error is reported. A value ranging from a 1024-bit value and a 2048-bit value may be used as the public key.

The CGA option 210 provides additional security service through the signature option 220 and the timestamp/nonce option 230 for the purposes of protecting retransmission attack and other security threat. FIG. 3B illustrates a data format of the signature option 220.

Specifically, the signature option 220 is an option for authenticating ND messages by signing the same using a sender's private key to provide for integrity of the messages. The receiver receives the sender's public key through the key information field 315 contained in the CGA option 210.

As shown in FIG. 3B, the signature option 220 includes a type field 321 representing a signature option among ND options, a length field 322 representing the overall length of the option field in units of 64 bits, a pad length field 323 representing the length of a padding field, a key hash field 324 containing the leftmost 128 bits among hash values obtained by executing a unidirectional hash function on the sender's public key, a digital signature field 325 containing values for messages signed using the sender's private key, and a padding field 326 for alignment of packets.

The sender signs the IPv6 header 110, the ICMPv6 header 120, the NDP message header, and the NDP options existing before the signature option using the sender's own private key and incorporates the signature value in the signature option 220 for transmission. The receiver compares the hash value obtained by executing the unidirectional hash function on the public key received through the CGA option 210 with the value received through the key hash field 324 contained in the signature option 220, and verifies the received public key. If the verification is completed, the signature value is then verified based on the verification result, thereby authenticating the sender and identifying the integrity of the message.

When the signature option 220 is used, the timestamp/nonce option 230 is necessarily added.

FIG. 3C illustrates a data format of a timestamp option of the timestamp/nonce option 230, and FIG. 3D illustrates a data format of a nonce option of the timestamp/nonce option 230.

The timestamp option and the nonce option are provided for retransmission attack tolerance service. In detail, in a case of a unidirectional message like in a multicast address, the timestamp option, in which prior configuration is not necessary, is used. On the other hand, in a case of a bidirectional message, e.g., a solicitation-advertisement message, the nonce option is used. In this case, in order to increase a security level of the bidirectional message, the timestamp option as well as the nonce option, are used such that the nonce option precedes the timestamp option.

As shown in FIG. 3C, the timestamp option includes a type field 331 representing a timestamp option among ND options, a length field 332 representing the overall length of the option field in units of 64 bits, and a timestamp field 333 representing a time required for generating a message. The timestamp field 333 consists of 64 bits, including 48 bits indicating seconds, and 16 bits indicating 1/64 k seconds.

As shown in FIG. 3D, the nonce option includes a type field 341 representing a nonce option among ND options, a length field 342 representing the overall length of the option field in units of 64 bits, and a nonce field 343 containing more than 48 bit random numbers arbitrarily selected by the sender.

The sender transmits an ND message with the timestamp option (FIG. 3C) added thereto and a solicitation-advertisement message with the nonce option (FIG. 3D) added thereto. In a case where the timestamp option and the nonce option are both added in a message, the nonce option necessarily precedes the timestamp option.

When a received message contains a signature option, the receiver checks whether there is a timestamp option or a nonce option. If neither option exists, the received message should be discarded.

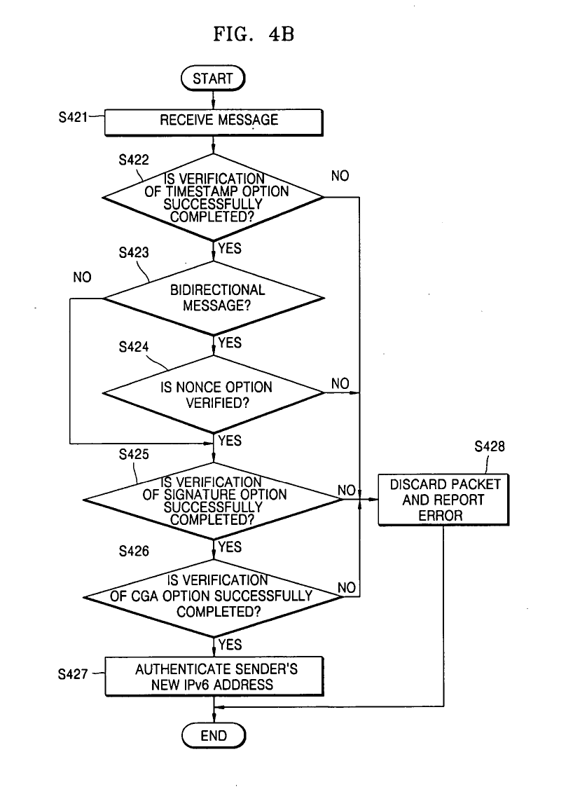

FIG. 4A is a flow chart diagram illustrating a process in which a non-configured host (sender) that first enters the network automatically generates its own IPv6 address.

First, the host enters the network in operation S401. Before operation S401, the host should have owned a pair of a public key and a private key. Otherwise, the security service for automatically generating a secure address cannot be rendered as indicated in operation S411.

If the host owns the public key/private key pair in operation S402, a CGA address is generated using a hash value and prefix information of a subnet in the network to which the host belongs in operation S403. The hash value is obtained by executing a unidirectional hash function on the host's interface ID using the host's public key and a predetermined tentative parameter. In operation S404, the signature option 220 is generated with the generated CGA address added to a sender's address field contained in the IPv6 header and the sender's public key added to the key information field 315 contained in the CGA option 210. A signature value is a hash value obtained in operation S405 by executing a unidirectional hash function on the sender's private key using the IPv6 header 110, the ICMPv6 header 120, the NDP message header and the ND message option 140 preceding the signature option 220. The generated signature value and the public key are signed using the unidirectional hash function and the leftmost 128 bit values are extracted to be included in the signature option 220 in operation S406.

After the signature option 220 is generated, the timestamp option 230 representing a time required for generating a message is generated in operation S407.

If it is determined in operation S408 that the generated message is a bidirectional message, e.g., a solicitation-advertisement message, the nonce option 230 containing more than 48 bit random numbers arbitrarily selected by the sender is generated in operation S409. Thereafter, the message is transmitted to a receiver in the network in operation S410.

FIG. 4B is a flow chart diagram illustrating a process in which a receiver that receives a message transmitted by the sender by the process verifies the automatically generated IPv6 address and authenticating the same.

First, the receiver receives a message in operation S421.

Then, the receiver checks whether the message is applicable to security protection service and verifies a timestamp of the message through use of the timestamp option in operation S422.

If the verification is successfully completed, it is identified whether the message is a bidirectional message in operation S423.

If the message is a bidirectional message, the nonce option is verified in operation S424. That is, it is checked whether the message is secured against a retransmission attack through a value of the nonce option, followed by verifying the signature option 220.

If the message is not a bidirectional message, the procedure goes directly to operation of verifying the signature option 220.

If verification of the timestamp or nonce option fails, the packet is discarded and an error is reported in operation S428.

It is checked whether a hash value obtained by executing a unidirectional hash function on the public key extracted from the key information field 315 contained in the CGA option 210, is identical with the value of the key hash field 324 in the signature option 220. A digital signature value in the signature option 220 is verified using the verified public key in operation S425. If verification of the signature option 220 is successfully completed, a CGA address in the CGA option 210 is verified in operation S426. If the CGA address is successfully verified, the receiver authenticates the IPv6 address that is newly generated by the sender in operation S427. If verification of signature or CGA fails, the packet is discarded and an error is reported in operation S428.

The method for automatically generating an address over the IPv6-based Internet according to the present invention can be implemented by codes recorded on a computer readable recording medium.

The computer readable recording media include all kinds of recording apparatuses for storing data readable by a computer system. Examples of the computer readable recording media include a ROM, a RAM, a CD-ROM, a magnetic tape, a hard disk, a floppy disk, a flash memory, an optical data storage device, and the like.

In addition, the method for automatically generating an address over the IPv6-based Internet according to the present invention can be implemented in the form of carrier wave, e.g., transmission over the Internet. Further, the computer readable recording media have codes distributed in computer systems connected through a computer communication network and the codes are stored and executed in a distributed manner.

A font ROM data structure according to present invention can also be implemented by computer readable codes recorded on a computer readable recording medium such as a ROM, a RAM, a CD-ROM, a magnetic tape, a hard disk, a floppy disk, a flash memory, an optical data storage device, and the like.

While the present invention has been particularly shown and described with reference to exemplary embodiments thereof, it will be understood by those of ordinary skill in the art that various changes in form and details may be made therein without departing from the spirit and scope of the present invention as defined by the following claims.

As described above, in the method for automatically generating and authenticating an address in the IPv6-based Internet according to the present invention, when a host enters the network in a Zero Configuration over the IPv6-based Internet, the address can be securely generated without using a manual key.

The present invention can also be applied to general IPv6 packet authentication or position authentication of a mobile node.

That is to say, the method for automatically generating and authenticating an address in the IPv6-based Internet according to the present invention, a non-configured entity (host) that enters the network for the first time over the IPv6-based Internet can generate its own CGA address in a cryptographical manner. This complies with the IPv6-based Zero Configuration architecture principle, thereby overcoming a prior art problem involved with the use of manual keys in order to protect a signaling message using IPsec AH.

In addition to an advantage in that a secured IPv6 address can be automatically generated, the present invention is advantageously applied to authentication of general IPv6 packets, authentication of message integrity and position authentication of a mobile note.

What is claimed is:

1. A data format of a Neighbor Discovery (ND) message of an ND protocol in the IPv6-based Internet, comprising:
a cryptographically generated address (CGA) option field containing a CGA address generated based on a public key;
a signature field containing signature values obtained by signing whole ND message using a sender's private key for authentication by a receiver;
a timestamp/nonce option field containing a time required for generating the ND message and predetermined random numbers.

2. The data format of claim 1, wherein the CGA option field comprises:
a first type field representing a CGA option among ND options;
a first length field representing the overall length of the CGA option field;
a collision count field representing the number of collisions occurred in the course of checking duplicity of the generated CGA address;
a modifier field representing a 128-bit random number used to increase a security level when generating the CGA address;
a key information field representing a sender's public key; and
a first padding field representing data for correcting alignment of packets.

3. The data format of claim 1, wherein the signature option field comprises:
a second type field representing a signature option among ND options;
a second length field representing the overall length of the signature option field;
a second padding field representing data for correcting alignment of packets;
a pad length field representing the length of the second padding field;
a key hash field containing the leftmost 128 bits among hash values obtained by executing a unidirectional hash function on the sender's public key; and
a digital signature field containing values obtained by signing messages using the sender's private key.

4. The data format of claim 1, wherein the timestamp/nonce option field comprises:
a third type field representing a timestamp option for performing a timestamp function;
a third length field representing the overall length of the timestamp option field;
a timestamp field representing a time required for generating a message;
a fourth type field representing a nonce option for performing a nonce function;
a fourth length field representing the overall length of the nonce option field; and
a nonce field containing random numbers arbitrarily selected by the sender.

5. A method for automatically generating an address in the IPv6-based Internet when a sender having a pair of a public key and a private key establishes a network connection, the method comprising:
generating a CGA address and a CGA option based on the public key and a predetermined parameter;
generating a signature option for verifying the CGA option;
additionally generating a timestamp option in a case where a unidirectional message is transmitted to the network, and additionally generating a nonce option containing random numbers in a case where a bidirectional message is transmitted to the network; and
adding the signature option, the timestamp option and the nonce option to a Neighbor Discovery (ND) option field to form an ND message, and transmitting the ND message to the network.

6. The method of claim 5, wherein the generating of the CGA address and the CGA option comprises:
generating an IPv6 header and an extension header of a packet to be transmitted;
generating the CGA address based on a hash value obtained by executing a hash function on an interface identification using the sender's public key; and
incorporating the CGA address into the CGA option.

7. The method of claim 5, wherein the generating of the signature option comprises:
signing the IPv6 header, ICMPv6 header, NDP message header, and NDP options preceding the signature option corresponding to a part of an NDP message using the sender's public key; and
signing the signed NDP message and adding the signature option to the NDP message.

8. A method for authenticating an IPv6 address generated by a sender that has received an IPv6 message with a timestamp/nonce option, a signature option, and a CGA option added thereto, the method comprising:
verifying a timestamp/nonce option;
if the verifying of the timestamp/nonce option is successfully completed, checking the message whether it is a bidirectional message or a unidirectional message, and verifying the nonce option for the bidirectional message or verifying the signature option for the unidirectional message; and
if the verifying of the time stamp is successfully completed, verifying the CGA option to check a CGA address, and authenticating the IPv6 address.

9. The method of claim 8, wherein the verifying of the CGA option comprises:
extracting a public key from the CGA option;
verifying whether the public key is identical with a value of a key hash field contained in the signature option;
if the verifying is successfully completed, identifying a digital signature value in the signature option based on the public key; and
if the identifying of the digital signature value is completed, checking the CGA address contained in the CGA option and authenticating the IPv6 address generated by the sender.
